(19) United States
(12) Patent Application Publication
(10) Pub. No.: US 2025/0042693 A1
(43) Pub. Date: Feb. 6, 2025

(54) ELEVATOR CAMERA ADJUSTMENT ASSISTANCE SYSTEM

(71) Applicant: Mitsubishi Electric Corporation, Tokyo (JP)

(72) Inventors: Satoshi SHIGA, Tokyo (JP); Takahide HIRAI, Tokyo (JP); Kiyotaka WATANABE, Tokyo (JP); Shoichi SHIMIZU, Tokyo (JP)

(73) Assignee: Mitsubishi Electric Corporation, Tokyo (JP)

(21) Appl. No.: 18/563,939

(22) PCT Filed: Jun. 2, 2021
(86) PCT No.: PCT/JP2021/021072

§ 371 Date: Nov. 24, 2023

(51) Int. Cl. B66B 5/00; B66B 3/00; G06T 7/80; H04N 7/18; H04N 17/00; H04N 23/695

(52) U.S. Cl. CPC B66B 5/0087; B66B 3/002; G06T 7/80; H04N 7/183; H04N 17/002; H04N 23/695

(57) ABSTRACT

In an adjustment assistance system, an image acquisition part acquires an image captured by a camera. The camera is provided on a car which runs in a hoistway of an elevator. A presentation part indicates on a surface thereof a calibration pattern to be captured by the camera in the hoistway. A detection part detects the calibration pattern in an image acquired by the image acquisition part. An attitude calculation part calculates an attitude of the camera based on an inclination, with respect to an optical axis of the camera, of a normal line to the surface of the presentation part indicating the calibration pattern detected by the detection part.

### TECHNICAL FIELD

The present disclosure relates to elevator camera adjustment assistance systems.

### BACKGROUND ART

Patent Literature 1 discloses an example of an elevator. In the elevator, a camera is mounted below a car. The camera captures the interior of a hoistway.

### PRIOR ART

### Patent Literature

[PTL 1]JP S63-123782

### SUMMARY OF THE INVENTION

### Problem to be Solved by the Invention

However, for the attitude of the camera on the elevator of Patent Literature 1, a deviation from a preset target attitude can arise. At this time, subjects being captured inside the hoistway may be out of the field of view of the camera, and thus the attitude of the camera need to be adjusted. However, just by visually observing the outer appearance of the camera and images captured by it, it can be difficult to determine whether the attitude of the camera has been adjusted.

The present disclosure relates to a solution to such a challenge. The present disclosure provides adjustment assistance systems that enable easier determination of whether the attitude of an elevator camera has been adjusted.

### Means to Solve the Problem

An elevator camera adjustment assistance system according to the present disclosure includes: an image acquisition part that acquires an image captured by a camera provided on a car which runs in a hoistway of an elevator; a presentation part that indicates on a surface thereof a calibration pattern to be captured by the camera in the hoistway; a detection part that detects the calibration pattern in an image acquired by the image acquisition part; and an attitude calculation part that calculates an attitude of the camera based on an inclination, with respect to an optical axis of the camera, of a normal line to the surface of the presentation part indicating the calibration pattern detected by the detection part.

### Advantageous Effect of Invention

With the adjustment assistance systems according to the present disclosure, it is possible to determine more easily whether the attitude of an elevator camera has been adjusted.

### BRIEF DESCRIPTION OF DRAWINGS

FIG. 1 is a configuration diagram of an elevator according to Embodiment 1.

FIG. 2 is a block diagram showing a configuration of an adjustment assistance system according to Embodiment 1.

FIG. 3 is a diagram which shows an example of adjustment to the attitude of the camera by means of the adjustment assistance system according to Embodiment 1.

FIG. 4 is a diagram which shows an example of adjustment to the attitude of the camera by means of the adjustment assistance system according to Embodiment 1.

FIG. 5 is a flowchart illustrating an example of the operation of the adjustment assistance system according to Embodiment 1.

FIG. 6 is a hardware configuration diagram of key components of the adjustment assistance system according to Embodiment 1.

FIG. 7 is a block diagram showing a configuration of the adjustment assistance system according to Embodiment 2.

FIG. 8 is a flowchart illustrating an example of operation of the adjustment assistance system according to Embodiment 2.

FIG. 9 is a flowchart illustrating an example of operation of the adjustment assistance system according to Embodiment 3.

FIG. 10 is a block diagram showing a configuration of the adjustment assistance system according to Embodiment 4.

FIG. 11 is a diagram which shows an example of adjustment to the attitude of the camera by means of the adjustment assistance system according to Embodiment 4.

FIG. 12 is a perspective view of the portable terminal according to Embodiment 5.

FIG. 13 is a block diagram showing a configuration of the adjustment assistance system according to Embodiment 6.

FIG. 14 is a diagram which shows an example of adjustment to the attitude of the camera by means of the adjustment assistance system according to Embodiment 6.

### DESCRIPTION OF EMBODIMENTS

Modes for practicing the subject of the present disclosure will be described with reference to the attached drawings. In the figures, the same or corresponding portions are given the same reference signs and redundant description is simplified or omitted as appropriate. The subject of the present disclosure is not limited to the following embodiments but modification to any component of an embodiment or omission of any component of an embodiment is possible within a scope not departing from the gist of the present disclosure.

### Embodiment 1

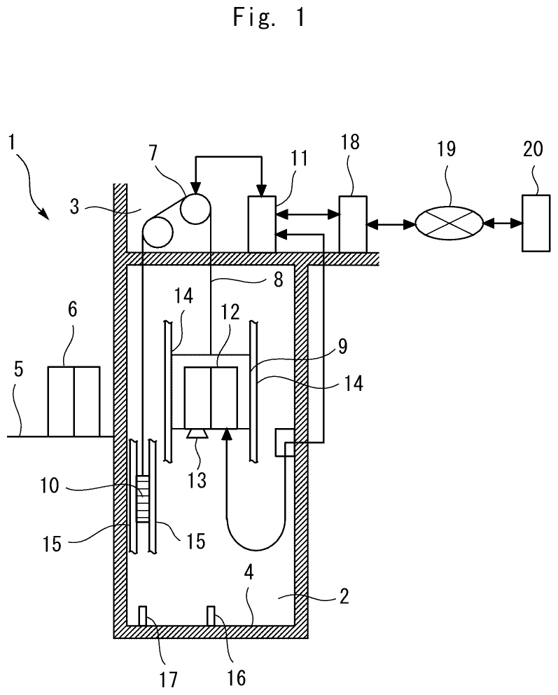

FIG. 1 is a configuration diagram of an elevator 1 according to Embodiment 1.

The elevator 1 is applied to a building with multiple floors, for example. A hoistway 2 is provided in the building to which the elevator 1 is applied. The hoistway 2 is a space spanning multiple floors. A machine room 3 is provided above the hoistway 2. A pit 4 is provided at a lower end of the hoistway 2. A hall 5 is provided at each floor. The hall 5 is a space adjacent to the hoistway 2. At the hall 5 on each floor, a hall entrance, not shown, is provided. The hall entrance is an opening in communication with the hoistway 2. A hatch door 6 is provided at the hall entrance. The hatch door 6 is a door that separates the hall 5 and the hoistway 2. The elevator 1 includes a traction machine 7, a main rope 8, a car 9, a counterweight 10, and a control panel 11.

The traction machine 7 is positioned in the machine room 3, for example. Where the machine room 3 for the elevator 1 is not provided, for example, the traction machine 7 may be positioned in an upper portion or a lower portion of the hoistway 2 or the like. The traction machine 7 includes a motor for generating torque and a sheave driven by the motor for rotation.

The main rope 8 is wound on the sheave of the traction machine 7. The main rope 8 supports the load of the car 9 on one side of the sheave of the traction machine 7. The main rope 8 supports the load of the counterweight 10 on the other side of the sheave of the traction machine 7. Balance with the load of the car 9 applied to the main rope 8 on one side of the sheave of the traction machine 7 is kept by the load of the counterweight 10 applied to the main rope 8 on the other side of the sheave of the traction machine 7. The main rope 8 is moved by the torque generated by the motor of the traction machine 7 such that it is wound onto the sheave of the traction machine 7 on either one of the car 9 side or the counterweight 10 side.

The car 9 is an apparatus that transports users of the elevator 1 riding in the car 9 and the like between multiple floors by running in the hoistway 2 in its running direction. In this example, the running direction of the car 9 is the vertical direction. The car 9 and the counterweight 10 run in the hoistway 2 in opposite directions to each other in the vertical direction in conjunction with the movement of the main rope 8 caused by the traction machine 7. The car 9 is equipped with a car door 12. The car door 12 is a door that separates the inside and the outside of the car 9. The car door 12 opens and closes in conjunction with the hatch door 6 on a certain floor so that users and the like can get on or off when the car 9 stops at the floor. The car 9 is equipped with a camera 13. The camera 13 is a device to capture the hoistway 2. The camera 13 is mounted to an external portion of the car 9. In this example, the camera 13 is mounted to a lower portion of the car 9. The camera 13 captures the lower side of the car 9. An optical axis of the camera 13 is oriented in parallel to the vertical direction, which is the running direction of the car 9. The camera 13 is mounted such as by magnets to a lower beam of a car frame supporting a cab into which users and the like get in the car 9, for example. In doing so, a string, a wire and the like for fall prevention attached to the lower beam may be attached to the camera 13.

The control panel 11 is a portion that controls the operation of the elevator 1. The control panel 11 is positioned in the machine room 3, for example. Where the machine room 3 for the elevator 1 is not provided, for example, the control panel 11 may be positioned in an upper portion or a lower portion of the hoistway 2 or the like. Operations of the elevator 1 that are controlled by the control panel 11 include the running of the car 9, for example. The control panel 11 acquires information on the condition of the elevator 1 so that the operation of the elevator 1 can be controlled. The control panel 11 is connected to devices for the elevator 1 so that operations on the condition of the elevator 1 can be acquired. Devices connected to the control panel 11 include devices for the traction machine 7 and the control panel 11, for example. Devices connected to the control panel 11 also include sensors, switches or the like provided in the hall 5 or the hoistway 2, for example.

In the hoistway 2, a pair of first guide rails 14 and a pair of second guide rails 15 are provided. The pair of first guide rails 14 are devices for guiding the running of the car 9. The pair of first guide rails 14 are disposed in parallel in the hoistway 2 along the vertical direction, which is the running direction of the car 9. The car 9 is positioned between the pair of first guide rails 14. Each of the first guide rails 14 may be divided into multiple portions in the vertical direction. The pair of second guide rails 15 are devices for guiding the running of the counterweight 10. The pair of second guide rails 15 are disposed in parallel in the hoistway 2 along the vertical direction, which is the running direction of the counterweight 10. The counterweight 10 is positioned between the pair of second guide rails 15. Each of the second guide rails 15 may be divided into multiple portions in the vertical direction.

In the pit 4, a first buffer 16 and a second buffer 17 are provided. The first buffer 16 is an apparatus for mitigating shock when the car 9 hits the bottom of the hoistway 2. The first buffer 16 is positioned below the car 9. The second buffer 17 is an apparatus for mitigating shock when the counterweight 10 hits the bottom of the hoistway 2. The second buffer 17 is positioned below the counterweight 10.

For the elevator 1, a remote monitoring apparatus 18 is applied. The remote monitoring apparatus 18 is a device used for monitoring of the condition of the elevator 1 from a remote location, for example. The remote monitoring apparatus 18 is connected to the control panel 11 and the like so that it can acquire information on the condition of the elevator 1. The remote monitoring apparatus 18 transmits acquired information to a central control apparatus 20 over a communication network 19, e.g., the internet or a telephone network. The central control apparatus 20 is a device that performs management of information on the condition of the elevator 1 and the like. The central control apparatus 20 is one or more server devices, for example. The central control apparatus 20 is positioned at a location such as an information center, for example. The information center is a location at which information on the elevator 1 is aggregated.

Here, images of the hoistway 2 that are captured by the camera 13 provided on the car 9 are used for inspection of the hoistway 2 or the like. Inspection of the hoistway 2 includes automated diagnosis such as in a diagnostic operation after occurrence of an earthquake, for example. Meanwhile, a deviation from the target attitude can occur with the attitude of the camera 13, such as due to repeated vibrations on the camera 13 associated with running and stopping of the car 9. Here, the attitude of the camera 13 is represented by the inclination of the camera 13 with respect to a preset direction or the like. The inclination of the camera 13 is the inclination of the optical axis of the camera 13, for example. The target attitude is an attitude at normal time preset for the camera 13. The target attitude is an attitude in which the optical axis of the camera 13 is oriented in parallel to the vertical direction, which is the running direction of the car 9, for example. If a deviation from the target attitude occurs with the attitude of the camera 13, it is possible that subjects being captured, such as devices located inside the hoistway 2, go out of the field of view of the camera 13. Then, an inspection using images captured by the camera 13 can fail. Accordingly, an operator who conducts maintenance work for the elevator 1 or the like performs work for adjusting the attitude of the camera 13 by means of an adjustment assistance system, not shown in FIG. 1, in maintenance work, for example. Here, work for adjusting the attitude of the camera 13 include procedures for checking the attitude of the camera 13 and modifying the attitude of the camera 13, for example.

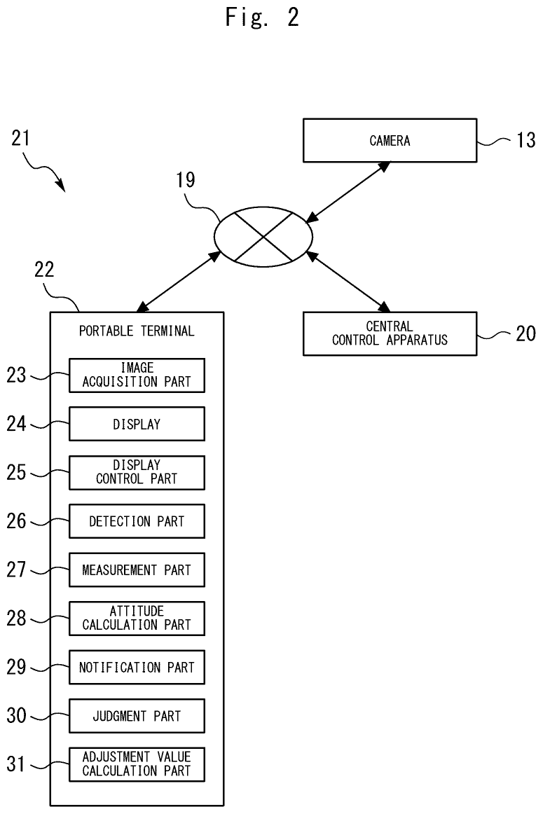

FIG. 2 is a block diagram showing a configuration of an adjustment assistance system 21 according to Embodiment 1.

In the adjustment assistance system 21, images captured by the camera 13 are used. Images captured by the camera 13 are transmitted to the central control apparatus 20 over the communication network 19. The camera 13 may also transmit images through the control panel 11 and the remote monitoring apparatus 18, for example. At the central control apparatus 20, the images captured by the camera 13 are stored in association with the times at which the images were captured.

The adjustment assistance system 21 includes a portable terminal 22. The portable terminal 22 is an information terminal that is transportable, e.g., a smartphone. The portable terminal 22 is carried by an operator. The portable terminal 22 incorporates a function of wirelessly communicating information. The portable terminal 22 is connected to the communication network 19. The portable terminal 22 is synchronized in time information with the camera 13 and the central control apparatus 20, for example. In the adjustment assistance system 21, an adjustment assistance program for the camera 13 is installed on the portable terminal 22. The adjustment assistance program is stored in a storage device, not shown, incorporated in the portable terminal 22, for example. Functions of the portable terminal 22 in the adjustment assistance system 21 are implemented by the adjustment assistance program and the like. The portable terminal 22 includes an image acquisition part 23, a display 24, a display control part 25, a detection part 26, a measurement part 27, an attitude calculation part 28, a notification part 29, a judgment part 30, and an adjustment value calculation part 31.

The image acquisition part 23 is a portion that acquires an image captured by the camera 13 from the central control apparatus 20, which stores the image. The image acquisition part 23 designates a time and acquires an image that was captured at the time, for example. The image acquisition part 23 designates the present time, for example, as the time at which an image was captured. In doing so, the image acquisition part 23 may also continuously acquire images being captured by the camera 13. Alternatively, the image acquisition part 23 may acquire an image captured by the camera 13 for a single time.

The display 24 is a device that shows information based on input signals. The display 24 is a liquid crystal display panel, for example. The display control part 25 is a portion that outputs a signal representing an image to the display 24. The display control part 25 outputs a signal representing an image of a calibration pattern for use in calculation of the attitude of the camera 13 or the like to the display 24. A calibration pattern refers to a regular design used for calibration of a device. A checker board pattern, a grid pattern, a Gray code pattern, or a pattern of dots arrayed in a lattice form are known as representative designs. The calibration pattern herein can also be called a planer pattern (planar reference pattern). The display 24 shows an image of the calibration pattern or the like based on the signal output from the display control part 25. Here, the display 24 indicates the calibration pattern by screen display on its surface. The display 24 is an example of a presentation part. The calibration pattern indicated by the display 24 is captured by the camera 13 by the operator pointing the surface of the display 24 toward the camera 13.

The detection part 26 is a portion that detects the calibration pattern indicated on the presentation part, such as the display 24, in an image acquired by the image acquisition part 23. The detection part 26 detects a feature point in the calibration pattern, e.g., a corner point of a checker board pattern, with a technique such as image processing.

The measurement part 27 is a portion that measures the inclination of the presentation part such as the display 24. The measurement part 27 includes an acceleration sensor, a tilt sensor or the like incorporated in the portable terminal 22 with the display 24. Since the measurement part 27 is provided integrally with the display 24, the inclination of the measurement part 27 itself corresponds to the inclination of the display 24. In this example, the measurement part 27 measures the inclination of the normal line to the surface of the display 24 from the vertical direction. Here, the measurement part 27 may indirectly measure the inclination of the normal line to the display 24 with respect to the vertical direction such as from inclination with respect to a different direction.

The attitude calculation part 28 is a portion that calculates the attitude of the camera 13 using, for example, a result of detection of the calibration pattern by the detection part 26 in an image acquired by the image acquisition part 23. The attitude calculation part 28 calculates the inclination of the optical axis of the camera 13 with respect to the vertical direction, which is the running direction of the car 9, as the attitude of the camera 13, for example. The attitude calculation part 28 may also calculate extrinsic parameters as the attitude of the camera 13. The extrinsic parameters for the camera 13 are conversion parameters between a fixed world coordinate system referenced to the hoistway 2 or the like and a camera coordinate system referenced to the camera 13.

The notification part 29 is a portion that provides audio notification of information to the operator who performs adjustment work on the camera 13 using the portable terminal 22. The notification part 29 includes a speaker, for example. The notification part 29 provides audio notification of information on whether or not the inclination of the normal line to the display 24 as measured by the measurement part 27 is an inclination within a notification range, for example. The notification range can be a range of inclination of the display 24 that is allowed in checking of the attitude of the camera 13, for example, and is preset with respect to the vertical direction, which is the running direction of the car 9. The notification part 29 notifies the operator by issuing a sound when the inclination of the normal line to the display 24 falls within the notification range, for example. In contrast, when the inclination of the normal line to the display 24 exceeds the notification range, the notification part 29 does not issue a sound. This enables the operator to obtain information on whether the inclination of the normal line to the display 24 is an inclination within the notification range or not according to existence or absence of a sound issued from the notification part 29. Alternatively, the notification part 29 may notify the operator by issuing different sounds based on whether the inclination of the normal line to the display 24 exceeds the notification range or not.

The judgment part 30 is a portion that judges an abnormality in the attitude of the camera 13 based on the difference between the attitude of the camera 13 calculated by the attitude calculation part 28 and the target attitude. The judgment part 30 judges that there is an abnormality in the attitude of the camera 13 when the inclination of the attitude of the camera 13 calculated by the attitude calculation part 28 relative to the target attitude exceeds a preset normal range, for example. The judgment part 30 judges that there is an abnormality in the attitude of the camera 13 when the angle between the orientation of the optical axis at the target attitude of the camera 13 and the orientation of the optical axis at the attitude of the camera 13 calculated by the attitude calculation part 28 is greater than a preset angle, for example. Alternatively, the judgment part 30 may judge that there is an abnormality in the attitude of the camera 13 when a rotation angle of the attitude of the camera 13 calculated by the attitude calculation part 28 about the optical axis relative to the target attitude is greater than a preset angle, for example.

The adjustment value calculation part 31 is a portion that calculates an adjustment value by which the attitude of the camera 13 is adjusted to the target attitude based on the attitude of the camera 13 calculated by the attitude calculation part 28. The adjustment value calculation part 31 calculates the angle between the orientation of the optical axis at the target attitude of the camera 13 and the orientation of the optical axis at the attitude of the camera 13 calculated by the attitude calculation part 28 as the adjustment value, for example.

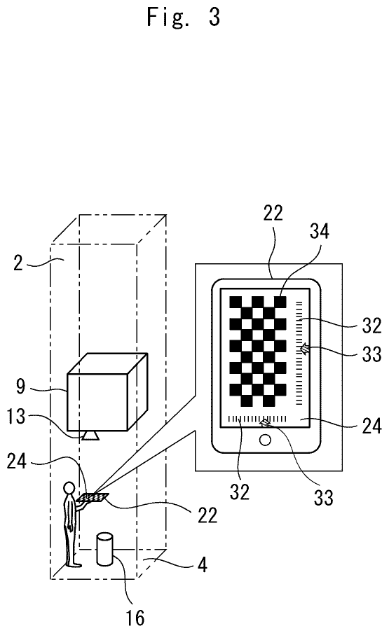

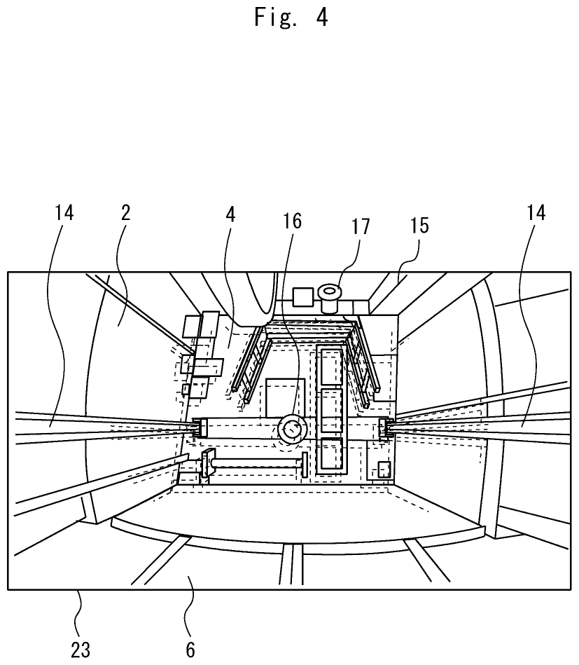

Next, with FIGS. 3 and 4, an example of adjustment to the attitude of the camera 13 by means of the adjustment assistance system 21 is described.

FIGS. 3 and 4 show an example of adjustment to the attitude of the camera 13 by means of the adjustment assistance system 21 according to Embodiment 1.

In FIG. 3, a perspective view of the hoistway 2 during adjustment work is shown.

In adjustment work on the camera 13, the operator enters the pit 4 from the hall 5 on the bottom floor, for example. The operator visually checks the attitude of the camera 13 in the pit 4. If a deviation of the attitude of the camera 13 from the target attitude can be confirmed such as from the outer appearance of the camera 13, the operator performs modification to the attitude of the camera 13. For example, if the camera 13 is equipped with a manual or automatic panning mechanism, the operator makes modification to the attitude of the camera 13 by operating the panning mechanism.

Alternatively, if the camera 13 is mounted to the car 9 by magnets or the like, the operator may make modification to the attitude of the camera 13 by reattaching the camera 13 to the car 9. After making modification to the attitude of the camera 13, for example, the operator uses the adjustment assistance system 21 to check the attitude of the camera 13. In doing so, the operator activates a function of checking the attitude of the camera 13 in the adjustment assistance system 21 by operating the portable terminal 22.

The display control part 25 obtains a result of measurement of the inclination of the normal line to the display 24 with respect to the vertical line from the measurement part 27. The display control part 25 generates information for an image representing the inclination of the display 24 measured by the measurement part 27. In this example, an image generated by the display control part 25 is an image that represents the vertical and horizontal inclinations of the display 24 with a scale 32 and an arrow 33 indicating the scale 32. The display control part 25 outputs signals representing the generated image and an image of the preset calibration pattern 34 to the display 24. In this example, the calibration pattern 34 is an image of a checker board pattern. In this example, the scale 32 and the arrow 33 representing the inclination of the display 24 are arranged along the perimeter of the calibration pattern 34.

The display 24 shows an image representing the calibration pattern 34 and the inclination of the display 24 based on the signals output by the display control part 25. FIG. 3 shows an example of indication on the display 24.

The operator points the display 24 up while holding the portable terminal 22 at a height at which the display 24 can be seen. In doing so, the operator adjusts the orientation of the display 24 such that the normal line to the display 24 is oriented in the vertical direction by making reference to the scale 32, the arrow 33 and the like indicated on the display 24. That is, the operator adjusts the orientation of the display 24 so that its surface becomes horizontal. During this, the operator may adjust the orientation of the display 24 while receiving audio notification from the notification part 29.

The image acquisition part 23 acquires the result of measurement of the inclination of the normal line to the display 24 with respect to the vertical direction from the measurement part 27. The image acquisition part 23 judges whether the inclination of the normal line to the display 24 measured by the measurement part 27 is an inclination within a calculation range. The calculation range can be a range of inclination of the display 24 that is allowed in checking of the attitude of the camera 13, for example, and is preset with respect to the vertical direction, which is the running direction of the car 9. The calculation range may be the same range as the notification range. If the image acquisition part 23 judges that the inclination of the display 24 measured by the measurement part 27 is an inclination within the calculation range, it acquires an image captured by the camera 13 from the central control apparatus 20 designating the time at which the measurement was performed. The image acquisition part 23 thereby acquires an image that was captured by the camera 13 when the surface of the display 24 was horizontal within the calculation range.

The detection part 26 detects the calibration pattern 34 in the image acquired by the image acquisition part 23. Here, if the detection part 26 has failed to detect the calibration pattern 34, the display control part 25 generates an image representing a failure of detection of the calibration pattern 34. The image can be an image of the calibration pattern 34 with changed colors, for example. The display control part 25 outputs a signal representing the generated image to the display 24. The display 24 shows an image representing a failure of detection of the calibration pattern 34 based on the signal output by the display control part 25. If the detection part 26 has detected the calibration pattern 34, the display control part 25 does not output a signal for an image representing a failure of detection of the calibration pattern 34 to the display 24. This allows the operator to get information on whether the detection of the calibration pattern 34 was successful or not according to existence or absence of an image representing a failure of detection of the calibration pattern 34 displayed on the display 24 or from the colors of the calibration pattern 34 indicated on the display 24.

The attitude calculation part 28 calculates the attitude of the camera 13 using, for example, the result of detection of the calibration pattern 34 by the detection part 26 in the image acquired by the image acquisition part 23. The inclination of the display 24 indicating the calibration pattern 34 detected from the image acquired by the image acquisition part 23 corresponds to the inclination of the normal line to the display 24 with respect to the optical axis of the camera 13. Here, since the image acquired by the image acquisition part 23 is an image that was captured by the camera 13 when the surface of the display 24 was horizontal within the calculation range, the inclination of the display 24 in the image corresponds to the inclination of the optical axis of the camera 13 with respect to the vertical direction. Thus, the attitude calculation part 28 calculates the inclination of the optical axis of the camera 13 with respect to the vertical direction as the attitude of the camera 13 based on the result of detection of the calibration pattern 34 by the detection part 26 from the image acquired by the image acquisition part 23.

The judgment part 30 judges an abnormality in the attitude of the camera 13 based on the difference between the attitude of the camera 13 calculated by the attitude calculation part 28 and the target attitude. Also, the adjustment value calculation part 31 calculates an adjustment value for the attitude of the camera 13 based on the difference between the attitude of the camera 13 calculated by the attitude calculation part 28 and the target attitude. The display control part 25 outputs signals representing the result of judgment by the judgment part 30 and the adjustment value calculated by the adjustment value calculation part 31 to the display 24. The display 24 shows the result of judgment on abnormality in the attitude of the camera 13 and the calculated adjustment value based on the signals output by the display control part 25. The operator is enabled to easily determine whether the attitude of the camera 13 has been adjusted or not based on the information shown on the display 24. The result of judgment by the judgment part 30 may also be stored in a storage device incorporated in the portable terminal 22, for example. This allows a confirmation result that the attitude of the camera 13 has been adjusted to be preserved as a work log of maintenance work and the like.

If the attitude of the camera 13 is judged to be abnormal, the operator modifies the attitude of the camera 13 using the adjustment assistance system 21. In doing so, the operator activates a function of modifying the attitude of the camera 13 in the adjustment assistance system 21 by operating the portable terminal 22.

FIG. 4 shows an example of display on the display 24 for the attitude modifying function.

In FIG. 4, an example of an image of the pit 4 as seen from above is shown.

The image acquisition part 23 acquires a past image captured by the camera 13 that was used in the most recent calculation of the attitude of the camera 13 by the attitude calculation part 28. For example, the image acquisition part 23 acquires, as the past image, an image at the time that was designated in the function of checking the attitude of the camera 13 when it was activated most recently, for example. The image acquisition part 23 also continuously acquires the image being captured by the camera 13 by designating the present time.

The display control part 25 generates an image which superimposes the past image acquired by the image acquisition part 23 and the current image being continuously acquired by the image acquisition part 23. The display control part 25 generates the image such as by alpha blending, which superimposes a semi-transparent past image on the current image, for example. Here, the display control part 25 displays the current image as a monochrome image. The display control part 25 displays the past image as a color image. The display control part 25 performs alpha blending using such an alpha channel that transparency increases as it goes from the center of the past image toward the outer periphery so that images of wall surfaces of the hoistway 2 and the like do not appear in the past image. The display control part 25 outputs a signal representing the generated image to the display 24. The display control part 25 may also output information on the adjustment value that was calculated in the function of checking the attitude of the camera 13 when it was activated most recently to the display 24 with the generated image.

The display 24 shows the generated image based on the signal output by the display control part 25. In FIG. 4, the current image is indicated by solid lines. The past image is indicated by dashed lines. Such superimposed display of the current image and the past image enables the operator to modify the attitude of the camera 13 while checking the amount of change in the attitude of the camera 13. After the operator modifies the attitude of the camera 13 with reference to the display 24, the operator checks the attitude of the camera 13. The operator repeats modification and checking of the attitude of the camera 13 until the attitude is judged to be normal.

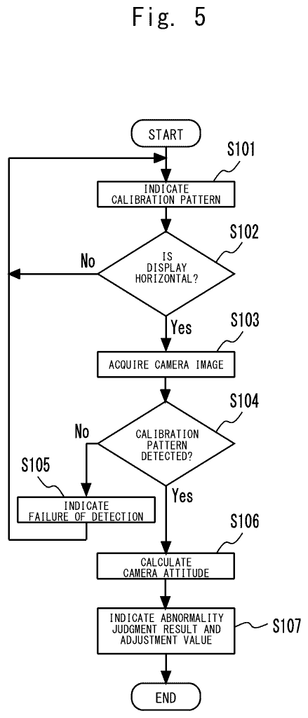

Next, with FIG. 5, an example of operation of the adjustment assistance system 21 is described.

FIG. 5 is a flowchart illustrating an example of the operation of the adjustment assistance system 21 according to Embodiment 1.

FIG. 5 shows an example of processing at the portable terminal 22 related to checking of the attitude of the camera 13.

The processing of FIG. 5 is started when the function of checking the attitude of the camera 13 is activated.

In step S101, the display control part 25 outputs a signal including information on an image of the calibration pattern 34 to the display 24. The display 24 shows the information including the image of the calibration pattern 34 on its surface. Then, processing in the adjustment assistance system 21 proceeds to step S102.

In step S102, the image acquisition part 23 judges whether the surface of the display 24 is horizontal within the calculation range based on the result of measurement by the measurement part 27. If the judgment results in No, processing in the adjustment assistance system 21 proceeds to step S101. If the judgment results in Yes, processing in the adjustment assistance system 21 proceeds to step S103.

In step S103, the image acquisition part 23 acquires an image captured by the camera 13 from the central control apparatus 20 designating the time of measurement at which the surface of the display 24 was judged to be horizontal in step S102. Then, processing in the adjustment assistance system 21 proceeds to step S104.

In step S104, the detection part 26 judges whether the calibration pattern 34 has been detected in the image acquired by the image acquisition part 23. If the judgment results in No, processing in the adjustment assistance system 21 proceeds to step S105.

If the judgment results in Yes, processing in the adjustment assistance system 21 proceeds to step S106.

In step S105, the display control part 25 outputs a signal for an image representing a failure of detection of the calibration pattern 34 to the display 24. The display 24 shows an image representing a failure of detection based on the signal output by the display control part 25. Then, processing in the adjustment assistance system 21 proceeds to step S101.

In step S106, the attitude calculation part 28 calculates the attitude of the camera 13 based on the inclination of the display 24 in the image acquired by the image acquisition part 23 with the display 24 indicating the calibration pattern 34 detected by the detection part 26 from the image. Here, the attitude calculation part 28 calculates the attitude of the camera 13 making use of the fact that this image is an image that was captured when the surface of the display 24 was horizontal within the calculation range. Then, processing in the adjustment assistance system 21 proceeds to step S107.

In step S107, the judgment part 30 judges whether there is an abnormality in the attitude of the camera 13 based on the difference between the attitude of the camera 13 calculated by the attitude calculation part 28 and the target attitude. Also, the adjustment value calculation part 31 calculates an adjustment value for the attitude of the camera 13 based on the difference between the attitude of the camera 13 calculated by the attitude calculation part 28 and the target attitude. The display control part 25 outputs signals representing the result of judgment by the judgment part 30 and the adjustment value calculated by the adjustment value calculation part 31 to the display 24. The display 24 shows the result of judgment on abnormality of the attitude of the camera 13 and the calculated adjustment value based on the signals output by the display control part 25. Then, processing in the adjustment assistance system 21 related to checking of the attitude of the camera 13 ends.

As described above, the adjustment assistance system 21 according to Embodiment 1 includes the image acquisition part 23, the display 24, the detection part 26, and the attitude calculation part 28. The image acquisition part 23 acquires an image captured by the camera 13. The camera 13 is provided on the car 9 which runs in the hoistway 2 of the elevator 1. The display 24 indicates on its surface the calibration pattern 34 to be captured by the camera 13 in the hoistway 2. The detection part 26 detects the calibration pattern 34 in the image acquired by the image acquisition part 23. The attitude calculation part 28 calculates the attitude of the camera 13 based on the inclination, with respect to the optical axis of the camera 13, of the normal line to the surface of the display 24 indicating the calibration pattern 34 detected by the detection part 26.

The adjustment assistance system 21 also includes the display control part 25. The display control part 25 outputs a signal representing the calibration pattern 34. The display 24 indicates the calibration pattern 34 on the surface in an indication based on the signal output by the display control part 25.

With such an arrangement, the attitude of the camera 13 is calculated based on the inclination of the calibration pattern 34 indicated on the display 24 such as after the attitude of the camera 13 is adjusted. This allows the operator to more easily determine whether the attitude of the camera 13 has been adjusted. Also, it is possible to log a confirmation result that the attitude of the camera 13 has been adjusted with the associated images. This facilitates work management of adjustment work on the camera 13.

The adjustment assistance system 21 also includes the measurement part 27. The measurement part 27 is provided integrally with the display 24. The measurement part 27 measures the inclination of the normal line to the display 24 with respect to the running direction of the car 9.

The attitude calculation part 28 also calculates the inclination of the camera 13 with respect to the running direction of the car 9 as the attitude of the camera 13, based on an image that was captured by the camera 13 when the inclination measured by the measurement part 27 was an inclination within a calculation range, which is preset with respect to the running direction of the car 9.

Here, assuming that a device indicating the calibration pattern 34 is to be set on the floor surface of the pit 4, the calibration pattern 34 on the device needs to be large because there is a certain distance from the camera 13 to the floor surface for securing working space for the operator. However, as the floor surface of the pit 4 has much irregularities, it can be difficult to set a large device at a designated inclination, such as being horizontal. By contrast, in the adjustment assistance system 21, the operator holds the portable terminal 22 which is displaying the calibration pattern 34 on the display 24 and points it toward the camera 13. As the distance from the camera 13 to the display 24 becomes shorter, it is no longer necessary to bring a large device displaying the calibration pattern 34 into the pit 4. Further, since acquisition of an image by the image acquisition part 23 is linked with the result of measurement by the measurement part 27, it is ensured that the surface of the display 24 indicating the calibration pattern 34 thereon is at a preset inclination within the calculation range in an image acquired by the image acquisition part 23. This enables easier and more accurate calculation of the attitude of the camera 13.

The adjustment assistance system 21 also includes the notification part 29. The notification part 29 provides audio notification of information on whether or not the inclination measured by the measurement part 27 is an inclination within a notification range, which is preset with respect to the running direction of the car 9.

Depending on the height of the camera 13, the operator may hold up the display 24 higher than his line of sight. Even in such a situation, the operator can easily adjust the inclination of the display 24 with audio notification from the notification part 29.

The display control part 25 also outputs a signal for information representing the inclination measured by the measurement part 27 to the display 24 which can be seen by the operator who performs adjustment work on the camera 13.

The display control part 25 also outputs a signal representing whether detection of the calibration pattern 34 by the detection part 26 was successful or not to the display 24.

Depending on the height of the camera 13, the operator can point the surface of the display 24 toward the camera 13 while looking at the display 24. In such a case, the operator can visually check the inclination of the display 24 and thus can adjust the inclination of the display 24 more easily. The operator also can visually check whether detection of the calibration pattern 34 was successful or not, thus can adjust the position of the display 24 and the like more easily.

The display control part 25 outputs a past image captured by the camera 13 that was used in the most recent calculation of the attitude of the camera 13 by the attitude calculation part 28 and a current image being captured by the camera 13 such that the past image and the current image are superimposed on each other on the display 24.

Such an arrangement allows the operator to check the adjustment value for modifying the attitude of the camera 13 on the display 24 in attitude modification work. This further facilitates the work of modifying the attitude of the camera 13.

The adjustment assistance system 21 also includes the judgment part 30. The judgment part 30 judges an abnormality in the attitude of the camera 13 based on the difference between the attitude of the camera 13 calculated by the attitude calculation part 28 and a preset target attitude.

Such an arrangement allows the operator to ascertain the existence of absence of an abnormality with the attitude of the camera 13 more easily.

The adjustment assistance system 21 also includes the adjustment value calculation part 31. The adjustment value calculation part 31 calculates an adjustment value by which the attitude of the camera 13 is adjusted to a preset target attitude based on the attitude of the camera 13 calculated by the attitude calculation part 28.

Such an arrangement allows the operator to ascertain a necessary adjustment value for modifying the attitude of the camera 13 before modification work, thus further facilitating modification to the attitude of the camera 13.

The display control part 25 may also output a past image that was captured by the camera 13 when the attitude of the camera 13 was the target attitude and a current image being captured by the camera 13 such that the past image and the current image are superimposed on each other on the display 24. An image when the attitude of the camera 13 is the target attitude can be an image that was taken when the judgment part 30 judged that there was no abnormality in the attitude of the camera 13 in the last maintenance work, for example. Alternatively, an image when the attitude of the camera 13 is the target attitude can be an image captured when the camera 13 is initially installed, for example.

Such an arrangement allows the operator to modify the attitude of the camera 13 while checking a target image on the display 24. This further facilitates the work of modifying the attitude of the camera 13.

In the elevator 1, the running direction of the car 9 may be inclined from the vertical direction. That is, the elevator 1 may also be an inclined elevator. Then, the measurement part 27 measures an inclination of the normal line to the surface of the display 24 from the running direction of the car 9. The operator may perform an initialization process to store the running direction of the car 9 in the measurement part 27 before adjustment work on the attitude of the camera 13. The initialization process is performed, for example, with the portable terminal 22 placed on the guide rails that are along the running direction of the car 9. With the initialization process, the measurement part 27 is enabled to measure an inclination from the running direction of the car 9.

The camera 13 may also be provided in an upper portion of the car 9. The operator then gets onto the outer upper portion of the car 9 to perform work to adjust the attitude of the camera 13. The camera 13 may also be provided both in an upper portion and a lower portion of the car 9.

In a case where the operator can check the inclination of the display 24 through an external device, e.g., a level attached to the portable terminal 22, the portable terminal 22 may not have the measurement part 27, which outputs measurement results as signals. In this case, the operator performs an operation of starting attitude calculation through the portable terminal 22 at a timing when the inclination of the display 24 has been checked, for example. The image acquisition part 23 acquires the time at which the operator performed the operation and acquires an image captured by the camera 13.

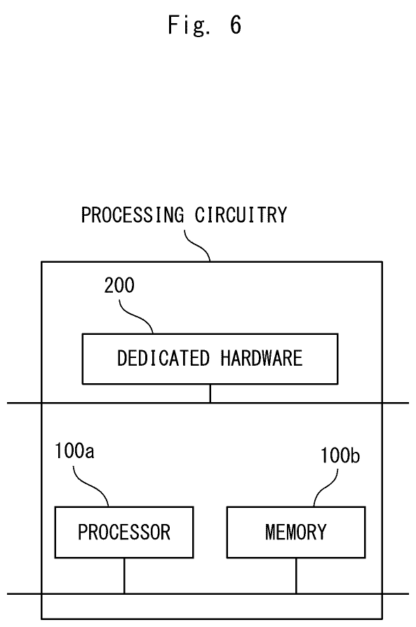

Next, with FIG. 6, an example of hardware configuration of the adjustment assistance system 21 is described.

FIG. 6 is a hardware configuration diagram of key components of the adjustment assistance system 21 according to Embodiment 1.

Functions of the adjustment assistance system 21 can be implemented by processing circuitry. The processing circuitry includes at least one processor 100a and at least one memory 100b. The processing circuitry may include at least one piece of dedicated hardware 200 together with the processor 100a and the memory 100b or in place of them.

When the processing circuitry includes the processor 100a and the memory 100b, the functions of the adjustment assistance system 21 are implemented by software, firmware, or combination of software and firmware. At least one of the software and the firmware is written as a program. The program is stored in the memory 100b. The processor 100a reads and executes the program stored in the memory 100b to implement the functions of the adjustment assistance system 21.

The processor 100a is also called a CPU (Central Processing Unit), a processing unit, an arithmetic unit, a microprocessor, a microcomputer, or a DSP. The memory 100b is formed from a non-volatile or volatile semiconductor memory, e.g., RAM, ROM, flash memory, EPROM, and EEPROM.

When the processing circuitry includes the dedicated hardware 200, the processing circuitry is implemented in a single circuit, a composite circuit, a programmed processor, a parallel programmed processor, an ASIC, an FPGA, or a combination thereof, for example.

Each function of the adjustment assistance system 21 can be individually implemented by the processing circuitry. Alternatively, the functions of the adjustment assistance system 21 can be collectively implemented by the processing circuitry. For the functions of the adjustment assistance system 21, some may be implemented in the dedicated hardware 200 and others may be implemented in software or firmware. In this manner, the processing circuitry implements the functions of the adjustment assistance system 21 in the dedicated hardware 200, software, firmware, or a combination thereof.

### Embodiment 2

In Embodiment 2, differences from the examples disclosed in Embodiment 1 will be described in particular detail. For features that are not described for Embodiment 2, any of the features from the examples disclosed in Embodiment 1 may be adopted.

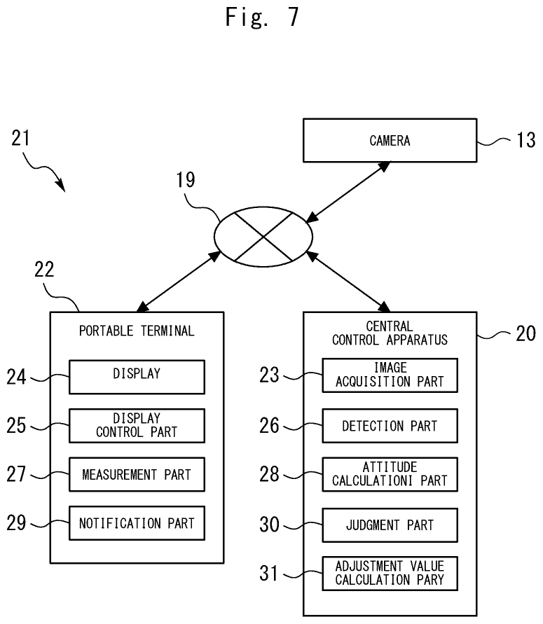

FIG. 7 is a block diagram showing a configuration of the adjustment assistance system 21 according to Embodiment 2.

In the adjustment assistance system 21, some or all of the functions performed by components such as the image acquisition part 23, the detection part 26, the attitude calculation part 28, the judgment part 30, and the adjustment value calculation part 31 may be incorporated in an apparatus external to the portable terminal 22 or the like. In this example, the image acquisition part 23, the detection part 26, the attitude calculation part 28, the judgment part 30, and the adjustment value calculation part 31 are incorporated in an apparatus located in the information center, e.g., the central control apparatus 20.

The image acquisition part 23 incorporated in the central control apparatus 20 acquires an image captured by the camera 13 via the communication network 19. The image acquisition part 23 stores the acquired image in association with the time the image was captured.

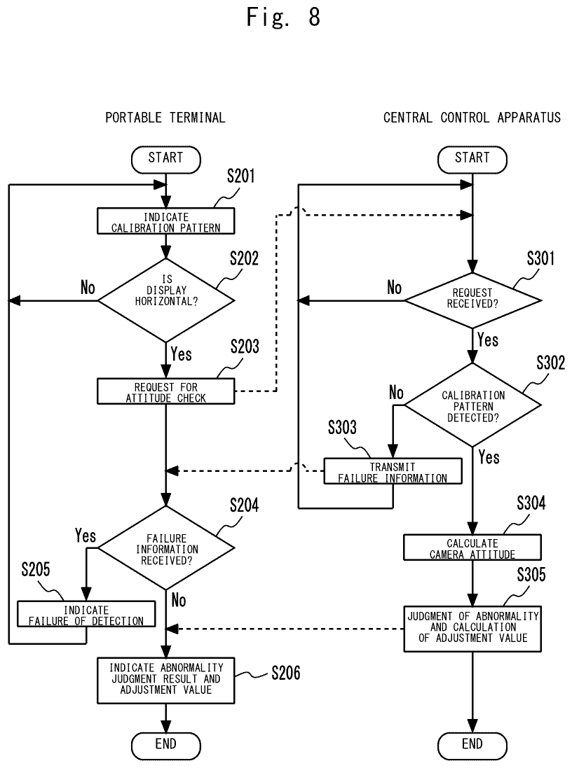

Next, with FIG. 8, an example of operation of the adjustment assistance system 21 is described.

FIG. 8 is a flowchart illustrating an example of operation of the adjustment assistance system 21 according to Embodiment 2.

FIG. 8 shows an example of processing for adjustment assistance related to checking of the attitude of the camera 13.

The processing at the portable terminal 22 in FIG. 8 is started when the function of checking the attitude of the camera 13 is activated.

In step S201, the display control part 25 outputs a signal including information on an image of the calibration pattern 34 to the display 24. The display 24 shows the information including an image of the calibration pattern 34 on its surface. Then, processing at the portable terminal 22 in the adjustment assistance system 21 proceeds to step S202.

In step S202, the portable terminal 22 judges whether the surface of the display 24 is horizontal within the calculation range in a similar manner to the image acquisition part 23 in step S101, based on the result of measurement by the measurement part 27. If the judgment results in No, processing at the portable terminal 22 in the adjustment assistance system 21 proceeds to step S201. If the judgment results in Yes, processing at the portable terminal 22 in the adjustment assistance system 21 proceeds to step S203.

In step S203, the portable terminal 22 transmits a request for attitude checking to the central control apparatus 20 designating the time of the measurement in which the surface of the display 24 was judged to be horizontal in step S202. Then, processing at the portable terminal 22 in the adjustment assistance system 21 proceeds to step S204.

Meanwhile, in step S301, the central control apparatus 20 judges whether a request for attitude checking has been received from the portable terminal 22. If the judgment results in No, processing at the central control apparatus 20 in the adjustment assistance system 21 proceeds to step S301 again. If the judgment results in Yes, processing at the central control apparatus 20 in the adjustment assistance system 21 proceeds to step S302.

In step S302, the detection part 26 judges whether the calibration pattern 34 has been detected in the image that was acquired by the image acquisition part 23 as the image captured at the time that was designated in the request for attitude checking. If the judgment results in No, processing at the central control apparatus 20 in the adjustment assistance system 21 proceeds to step S303. If the judgment results in Yes, processing at the central control apparatus 20 in the adjustment assistance system 21 proceeds to step S304.

In step S303, the central control apparatus 20 transmits information representing a failure of detection of the calibration pattern 34 by the detection part 26 to the portable terminal 22. Then, processing at the central control apparatus 20 in the adjustment assistance system 21 proceeds to step S301.

In step S304, the attitude calculation part 28 calculates the attitude of the camera 13 based on the inclination of the display 24 in the image acquired by the image acquisition part 23 with the display 24 indicating the calibration pattern 34 detected by the detection part 26 from the image. In doing so, the attitude calculation part 28 calculates the attitude of the camera 13 making use of the fact that this image is an image that was captured when the surface of the display 24 was horizontal within the calculation range. Then, processing at the central control apparatus 20 in the adjustment assistance system 21 proceeds to step S305.

In step S305, the judgment part 30 judges whether there is an abnormality in the attitude of the camera 13 based on the difference between the attitude of the camera 13 calculated by the attitude calculation part 28 and the target attitude. Also, the adjustment value calculation part 31 calculates an adjustment value for the attitude of the camera 13 based on the difference between the attitude of the camera 13 calculated by the attitude calculation part 28 and the target attitude. The central control apparatus 20 transmits information representing the result of judgment by the judgment part 30 and the adjustment value calculated by the adjustment value calculation part 31 to the portable terminal 22. Then, processing at the central control apparatus 20 in the adjustment assistance system 21 related to checking of the attitude of the camera 13 ends.

Meanwhile in step S204, the portable terminal 22 judges whether information representing a failure of detection of the calibration pattern 34 by the detection part 26 has been received from the central control apparatus 20. If the judgment results in Yes, processing at the portable terminal 22 in the adjustment assistance system 21 proceeds to step S205. If the judgment results in No, processing at the portable terminal 22 in the adjustment assistance system 21 proceeds to step S206.

In step S205, the display control part 25 outputs a signal for an image representing a failure of detection of the calibration pattern 34 to the display 24 based on the information received from the central control apparatus 20. The display 24 shows an image representing a failure of detection based on the signal output by the display control part 25. Then, processing at the portable terminal 22 in the adjustment assistance system 21 proceeds to step S201.

In step S206, the display control part 25 outputs signals representing the result of judgment by the judgment part 30 and the adjustment value calculated by the adjustment value calculation part 31 to the display 24 based on the information received from the central control apparatus 20. The display 24 shows the result of judgment on abnormality in the attitude of the camera 13 and the calculated adjustment value based on the signals output by the display control part 25. Then, processing at the portable terminal 22 in the adjustment assistance system 21 related to checking of the attitude of the camera 13 ends.

As described above, in the adjustment assistance system 21 according to Embodiment 2, the image acquisition part 23, the detection part 26, the attitude calculation part 28, the judgment part 30, and the adjustment value calculation part 31 are incorporated in the central control apparatus 20. With such an arrangement as well, the attitude of the camera 13 is calculated based on the inclination of the calibration pattern 34 indicated on the display 24 such as after the attitude of the camera 13 is adjusted. This allows the operator to more easily determine whether the attitude of the camera 13 has been adjusted. Also, it is possible to log a confirmation result that the attitude of the camera 13 has been adjusted with the associated images. This facilitates work management of adjustment work on the camera 13.

### Embodiment 3

In Embodiment 3, differences from the examples disclosed in Embodiment 1 or 2 will be described in particular detail. For features that are not described for Embodiment 3, any of the features from the examples disclosed in Embodiment 1 or 2 may be adopted.

In this example, the configuration of adjustment assistance system 21 is similar to the configuration shown in the block diagram of FIG. 2.

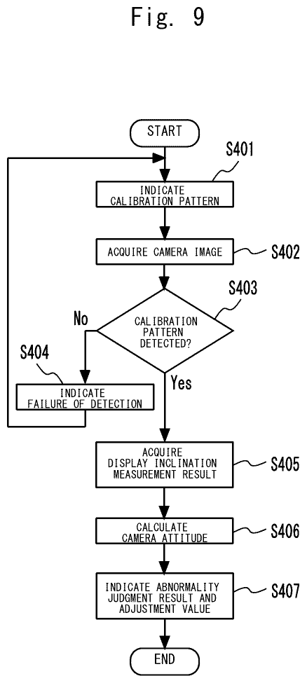

FIG. 9 is a flowchart illustrating an example of operation of the adjustment assistance system 21 according to Embodiment 3.

FIG. 9 shows an example of processing at the portable terminal 22 related to checking of the attitude of the camera 13.

The processing of FIG. 9 is started when the function of checking the attitude of the camera 13 is activated.

In step S401, the display control part 25 outputs a signal including information on an image of the calibration pattern 34 to the display 24. The display 24 shows the information including the image of the calibration pattern 34 on its surface. Then, processing in the adjustment assistance system 21 proceeds to step S402.

In step S402, the image acquisition part 23 acquires an image captured by the camera 13 from the central control apparatus 20 designating the present time. Then, processing in the adjustment assistance system 21 proceeds to step S403.

In step S403, the detection part 26 judges whether the calibration pattern 34 has been detected in the image acquired by the image acquisition part 23. If the judgment results in No, processing in the adjustment assistance system 21 proceeds to step S404.

If the judgment results in Yes, processing in the adjustment assistance system 21 proceeds to step S405.

In step S404, the display control part 25 outputs a signal for an image representing a failure of detection of the calibration pattern 34 to the display 24. The display 24 shows an image representing a failure of detection based on the signal output by the display control part 25. Then, processing in the adjustment assistance system 21 proceeds to step S401.

In step S405, the attitude calculation part 28 acquires the result of measurement by the measurement part 27 at the time when the image acquired by the image acquisition part 23 was captured, for the inclination of the normal line to the display 24 with respect to the vertical direction, which is the running direction of the car 9. Then, processing in the adjustment assistance system 21 proceeds to step S406.

In step S406, the attitude calculation part 28 calculates the attitude of the camera 13 based on the inclination of the display 24 in the image acquired by the image acquisition part 23 with the display 24 indicating the calibration pattern 34 detected by the detection part 26 from the image. Here, the attitude calculation part 28 calculates the attitude of the camera 13 by making use of the inclination of the normal line to the display 24 with respect to the vertical direction at the time the image was captured, acquired in step S405. For example, the attitude calculation part 28 uses the result of detection by the detection part 26 to calculate the relationship between the orientation of the optical axis the camera 13 and the orientation of the normal line to the display 24. The attitude calculation part 28 obtains the relationship between the orientation of the normal line to the display 24 and the vertical direction according to the result of measurement by the measurement part 27. The attitude calculation part 28 calculates the relationship between the orientation of the optical axis of the camera 13 and the vertical direction, based on the relationship between the orientation of the optical axis the camera 13 and the orientation of the normal line to the display 24 and the relationship between the orientation of the normal line to the display 24 and the vertical direction. From the thus calculated relationship, the attitude calculation part 28 calculates the attitude of the camera 13. Then, processing in the adjustment assistance system 21 proceeds to step S407.

In step S407, the judgment part 30 judges whether there is an abnormality in the attitude of the camera 13 based on the difference between the attitude of the camera 13 calculated by the attitude calculation part 28 and the target attitude. Also, the adjustment value calculation part 31 calculates the adjustment value for the attitude of the camera 13 based on the difference between the attitude of the camera 13 calculated by the attitude calculation part 28 and the target attitude. The display control part 25 outputs signals representing the result of judgment by the judgment part 30 and the adjustment value calculated by the adjustment value calculation part 31 to the display 24. The display 24 shows the result of judgment on abnormality in the attitude of the camera 13 and the calculated adjustment value based on the signals output by the display control part 25. Then, processing in the adjustment assistance system 21 related to checking of the attitude of the camera 13 ends.

As described above, the attitude calculation part 28 of the adjustment assistance system 21 according to Embodiment 3 acquires the inclination of the display 24 that was measured by the measurement part 27 when the image in which the detection part 26 has detected the calibration pattern 34 was captured by the camera 13. Based on the acquired inclination, the attitude calculation part 28 calculates the inclination of the camera 13 relative to the running direction of the car 9 as the attitude of the camera 13.

With such an arrangement, the attitude of the camera 13 can be calculated even when there is some deviation in an adjustment to the inclination of the display 24, as long as the deviation is to such an extent that allows the detection of the calibration pattern 34 by the detection part 26. This allows calculation of the attitude of the camera 13 to be done more easily.

### Embodiment 4

In Embodiment 4, differences from the examples disclosed in Embodiments 1 to 3 will be described in particular detail. For features that are not described for Embodiment 4, any of the features from the examples disclosed in Embodiments 1 to 3 may be adopted.

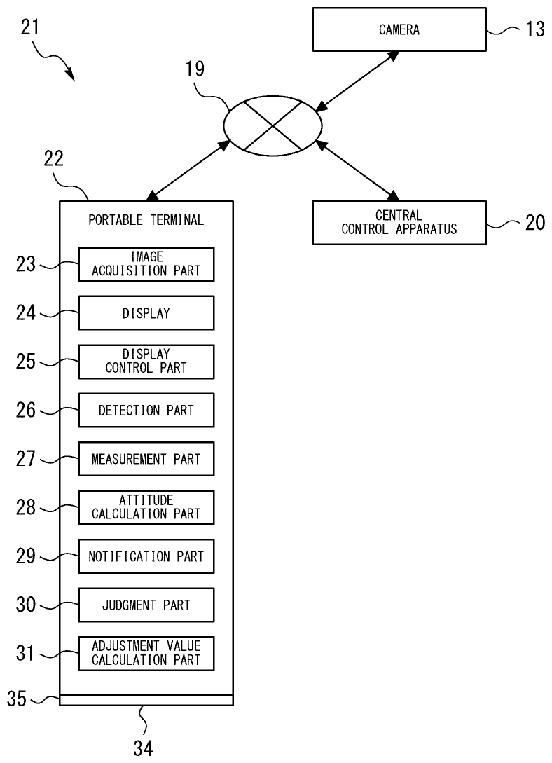

FIG. 10 is a block diagram showing a configuration of the adjustment assistance system 21 according to Embodiment 4.

The portable terminal 22 includes a calibration plate 35. The calibration plate 35 is a plate-like member that indicates the calibration pattern 34 via an image pre-applied to its surface. The calibration plate 35 is an example of the presentation part. On the calibration plate 35, an image of the calibration pattern 34 is applied by printing or label application, for example. In this example, the calibration plate 35 is positioned on the back face of the portable terminal 22, that is, opposite the display 24. The calibration plate 35 may also be the back face portion of the casing of the portable terminal 22 itself.

Since the measurement part 27 is provided integrally in the portable terminal 22 together with the calibration plate 35, which serves as the presentation part, the inclination of the measurement part 27 itself corresponds to the inclination of the calibration plate 35. In this example, the measurement part 27 measures the inclination of the normal line to the surface of the calibration plate 35 from the vertical direction. Here, the measurement part 27 may also indirectly measure the inclination of the normal line to the calibration plate 35 with respect to the vertical direction such as from an inclination with respect to a different direction.

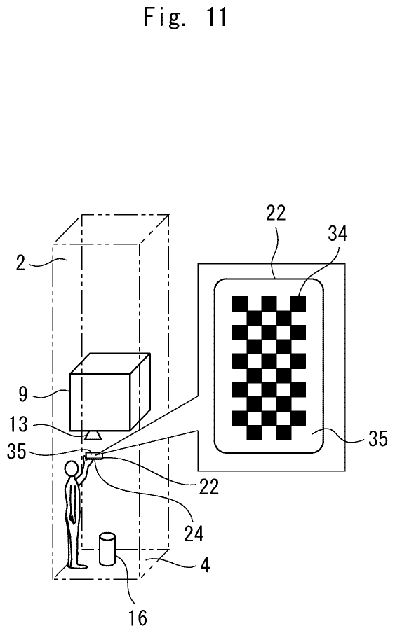

FIG. 11 shows an example of adjustment to the attitude of the camera 13 by means of the adjustment assistance system 21 according to Embodiment 4.

In FIG. 11, a perspective view of the hoistway 2 during adjustment work is shown.

The operator activates the function of checking the attitude of the camera 13 in the adjustment assistance system 21 by operating the portable terminal 22 in the pit 4.

The display control part 25 acquires the result of measurement of the inclination of the normal line to the calibration plate 35 with respect to the vertical direction from the measurement part 27. The display control part 25 generates information for images of the scale 32 and the arrow 33, for example, representing the inclination of the calibration plate 35 measured by the measurement part 27. The display control part 25 outputs a signal representing the generated images to the display 24.

The operator points the calibration plate 35 up while holding the portable terminal 22. In doing so, the operator can point the calibration plate 35 up while checking the display 24 from below by lifting the portable terminal 22 higher than his line of sight. The operator adjusts the orientation of the calibration plate 35 so that the normal line to the calibration plate 35 is oriented in the vertical direction by making reference to the scale 32, the arrow 33 and the like indicated on the display 24. That is, the operator adjusts the orientation of the calibration plate 35 such that its surface becomes horizontal. During this, the notification part 29 provides audio notification of information on whether the inclination of the normal line to the calibration plate 35 measured by the measurement part 27 is an inclination within the notification range or not. The operator may also adjust the orientation of the calibration plate 35 while receiving audio notification from the notification part 29.

The image acquisition part 23 acquires the result of measurement of the inclination of the normal line to the calibration plate 35 with respect to the vertical direction from the measurement part 27. The image acquisition part 23 judges whether the inclination of the normal line to the calibration plate 35 measured by the measurement part 27 is an inclination within the calculation range. When the image acquisition part 23 judges that the inclination of the calibration plate 35 measured by the measurement part 27 is an inclination within the calculation range, it acquires an image captured by the camera 13 from the central control apparatus 20 designating the time at which the measurement was performed. In this way, the image acquisition part 23 acquires an image that was captured by the camera 13 when the surface of the calibration plate 35 was horizontal within the calculation range.

The detection part 26 detects the calibration pattern 34 in the image acquired by the image acquisition part 23. Here, if the detection part 26 has failed to detect the calibration pattern 34, the display control part 25 generates an image representing a failure of detection of the calibration pattern 34. The image is a character string or an icon representing a failure of detection, for example. The display control part 25 outputs a signal representing the generated image to the display 24. The display 24 shows an image representing a failure of detection of the calibration pattern 34 based on the signal output by the display control part 25. If the detection part 26 has detected the calibration pattern 34, the display control part 25 does not output a signal for an image representing a failure of detection of the calibration pattern 34 to the display 24. This allows the operator to get information on whether the detection of the calibration pattern 34 was successful or not according to existence or absence of an image representing a failure of detection of the calibration pattern 34 displayed on the display 24.

The attitude calculation part 28 calculates the attitude of the camera 13 using, for example, the result of detection of the calibration pattern 34 by the detection part 26 in the image acquired by the image acquisition part 23. The inclination of the calibration plate 35 indicating the calibration pattern 34 detected from the image acquired by the image acquisition part 23 corresponds to the inclination of the normal line to the calibration plate 35 with respect to the optical axis of the camera 13. Here, since the image acquired by the image acquisition part 23 is an image that was captured by the camera 13 when the surface of the calibration plate 35 was horizontal within the calculation range, the inclination of the calibration plate 35 in the image corresponds to the optical axis of the camera 13 with respect to the vertical direction. Thus, the attitude calculation part 28 calculates the inclination of the optical axis of the camera 13 with respect to the vertical direction as the attitude of the camera 13 based on the result of detection of the calibration pattern 34 by the detection part 26 from the image acquired by the image acquisition part 23.

As described above, the adjustment assistance system 21 according to Embodiment 4 includes the image acquisition part 23, the calibration plate 35, the detection part 26, and the attitude calculation part 28. The image acquisition part 23 acquires an image captured by the camera 13. The camera 13 is provided on the car 9 which runs in the hoistway 2 of the elevator 1. The calibration plate 35 indicates the calibration pattern 34 to be captured by the camera 13 in the hoistway 2 on its surface. The detection part 26 detects the calibration pattern 34 in the image acquired by the image acquisition part 23. The attitude calculation part 28 calculates the attitude of the camera 13 based on the inclination, with respect to the optical axis of the camera 13, of the normal line to the surface of the calibration plate 35 indicating the calibration pattern 34 detected by the detection part 26.

Also, the calibration plate 35 indicates the calibration pattern 34 via an image pre-applied to its surface.

With such an arrangement, the attitude of the camera 13 is calculated based on the inclination of the calibration pattern 34 indicated on the calibration plate 35 such as after the attitude of the camera 13 is adjusted. This allows the operator to more easily determine whether the attitude of the camera 13 has been adjusted. Also, it is possible to log a confirmation result that the attitude of the camera 13 has been adjusted with the associated images. This facilitates work management of adjustment work on the camera 13.

The display 24 is positioned opposite the surface of the calibration plate 35.

Such an arrangement allows the operator to bring the surface of the calibration plate 35 close to the camera 13 more easily while checking the indication on the display 24. Also, as the display 24 and the calibration plate 35 are integral and easier to handle, ease of adjustment work on the camera 13 is improved.

The portable terminal 22 may also be a dedicated apparatus for the adjustment assistance system 21, for example. The portable terminal 22 then may not have the display 24 and a display controller. The results of attitude calculation by the attitude calculation part 28 and the like are recorded at the central control apparatus 20, for example.

The calibration plate 35 may also be a separate apparatus from the portable terminal 22. Then, the measurement part 27 is an acceleration sensor or an inclination sensor integrally provided with the calibration plate 35, for example. The measurement part 27 communicates results of measurement with the portable terminal 22 or the central control apparatus 20 by wire or wirelessly.

### Embodiment 5

In Embodiment 5, differences from the examples disclosed in Embodiments 1 to 4 will be described in particular detail. For features that are not described for Embodiment 5, any of the features from the examples disclosed in Embodiments 1 to 4 may be adopted.

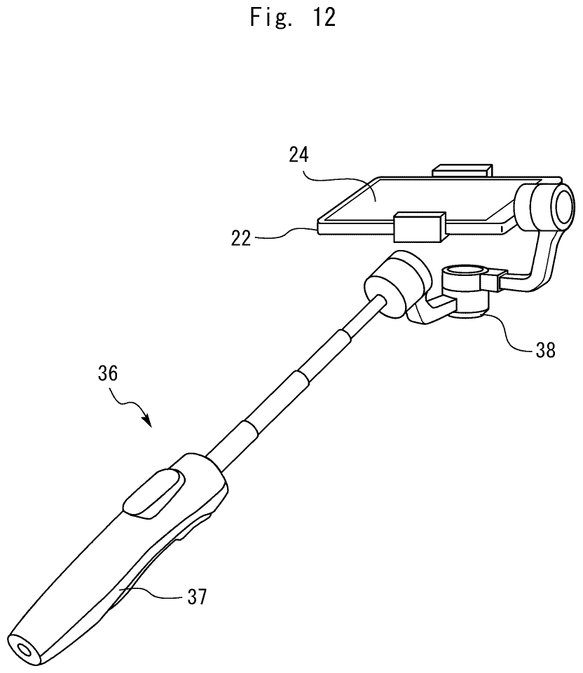

FIG. 12 is a perspective view of the portable terminal 22 according to Embodiment 5.

In the adjustment assistance system 21, a holder 36 is attached to the portable terminal 22. The holder 36 includes a handle 37 and a stabilizer 38. The handle 37 is a portion to be held by the operator. The stabilizer 38 is a portion that holds the portable terminal 22 so as to maintain the inclination of the presentation part, such as the display 24 or the calibration plate 35. When a calibration plate 35 separate from the portable terminal 22 is used as the presentation part, the stabilizer 38 will hold the calibration plate 35. The stabilizer 38 maintains the inclination of the presentation part such as the display 24 with a gimbal mechanism, for example.

The operator holds the handle 37 of the holder 36 and points up the surface of the presentation part, such as the display 24 or the calibration plate 35, when checking the attitude of the camera 13. In doing so, dispersions in the inclination of the presentation part indicating the calibration pattern 34 are suppressed by the stabilizer 38. As the calibration pattern 34 is stably captured, checking of the attitude of the camera 13 can be performed more stably.

### Embodiment 6

In Embodiment 6, differences from the examples disclosed in Embodiments 1 to 5 will be described in particular detail. For features that are not described for Embodiment 6, any of the features from the examples disclosed in Embodiments 1 to 5 may be adopted.

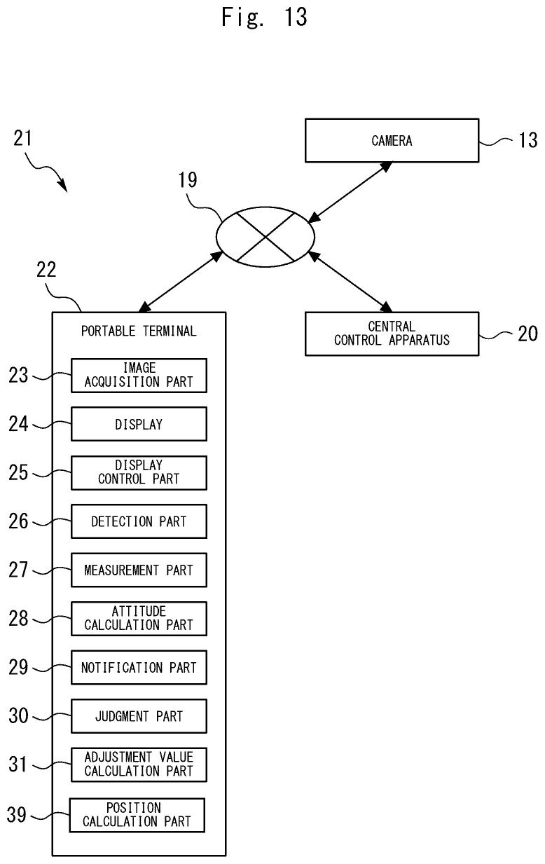

FIG. 13 is a block diagram showing a configuration of the adjustment assistance system 21 according to Embodiment 6.

The portable terminal 22 includes a position calculation part 39. The position calculation part 39 is a portion that calculates the position of the camera 13 using, for example, a result of detection of the calibration pattern 34 by the detection part 26 in an image acquired by the image acquisition part 23. In this example, the position calculation part 39 calculates the position of the camera 13 in a horizontal plane perpendicular to the vertical direction, which is the running direction of the car 9.

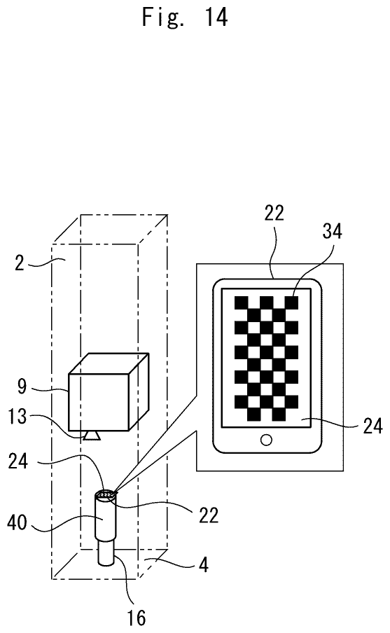

FIG. 14 shows an example of adjustment to the attitude of the camera 13 by means of the adjustment assistance system 21 according to Embodiment 6.

In FIG. 14, a perspective view of the hoistway 2 during adjustment work is shown.

The operator places a buffer cap 40 over the top of the first buffer 16 so that working space is secured when performing work in the pit 4. The buffer cap 40 is a tool long in the vertical direction, for example. In this example, the top of the buffer cap 40 has a flat horizontal surface facing up.

Here, the camera 13 is set at a position offset from the center axis of the first buffer 16 in the horizontal direction. This prevents the camera 13 from hitting the buffer cap 40 when the car 9 descends and approaches the buffer cap 40 placed on the first buffer 16.

In adjustment work on the camera 13, the operator activates the function of checking the attitude of the camera 13 in the adjustment assistance system 21 by operating the portable terminal 22. The operator then places the portable terminal 22 on top of the buffer cap 40 such that the surface of the display 24 and the like indicating the calibration pattern 34 faces up.

An image processing part acquires an image captured by the camera 13 from the central control apparatus 20 designating the present time after the portable terminal 22 is placed on the top of the buffer cap 40. Here, the image processing part regards the time when a preset time passed since the attitude checking function was activated as a time after the portable terminal 22 is placed on the top of the buffer cap 40. Alternatively, the image processing part may judge that the portable terminal 22 has been placed on the top of the buffer cap 40 if the portable terminal 22 has been at rest longer than a preset period of time, based on a result of measurement from an acceleration sensor incorporated in the portable terminal 22, for example. The surface of the display 24 is horizontal when the portable terminal 22 is placed on the top of the buffer cap 40. Accordingly, the image acquisition part 23 can acquire an image that is captured by the camera 13 when the display 24 is horizontal.

The detection part 26 detects the calibration pattern 34 in the image acquired by the image acquisition part 23.

The attitude calculation part 28 calculates the attitude of the camera 13 using, for example, the result of detection of the calibration pattern 34 by the detection part 26 in the image acquired by the image acquisition part 23. The inclination of the display 24 indicating the calibration pattern 34 detected from the image acquired by the image acquisition part 23 corresponds to the inclination of the normal line to the display 24 with respect to the optical axis of the camera 13. Here, since the image acquired by the image acquisition part 23 is an image that was captured by the camera 13 when the surface of the display 24 was horizontal, the inclination of the display 24 in the image corresponds to the inclination of the optical axis of the camera 13 with respect to the vertical direction. Thus, the attitude calculation part 28 calculates the inclination of the optical axis of the camera 13 with respect to the vertical direction as the attitude of the camera 13 based on the result of detection of the calibration pattern 34 by the detection part 26 from the image acquired by the image acquisition part 23.

The position calculation part 39 calculates the position of the camera 13 using, for example, the result of detection of the calibration pattern 34 by the detection part 26 in the image acquired by the image acquisition part 23. The position calculation part 39 performs calculation of position after the judgment part 30 judges that there is no abnormality with the attitude of the camera 13 calculated by the attitude calculation part 28, for example. When the attitude of the camera 13 is the target attitude, the center of an image captured by the camera 13 indicates an area on an extension of the path of the camera 13, which moves along the running direction of the car 9. In this example, when the attitude of the camera 13 is the target attitude, the center of an image captured by the camera 13 represents an area vertically below the camera 13. Since the presentation part such as the display 24 indicating the calibration pattern 34 to be detected by the detection part 26 is at the top of the buffer cap 40, the position calculation part 39 can calculate the horizontal position of the camera 13 relative to the first buffer 16 based on the position of the calibration pattern 34 in the image.

The judgment part 30 judges an abnormality in the position of the camera 13 based on the position of the camera 13 calculated by the position calculation part 39. The judgment part 30 judges that there is an abnormality in the position of the camera 13 as the positional offset between the camera 13 and the first buffer 16 is not sufficient when, for example, the distance between the position of the calibration pattern 34 detected by the detection part 26 in the image and the center of the image is within a preset range.

When the position of the camera 13 is judged to be abnormal, the operator modifies the position of the camera 13 using the adjustment assistance system 21. The operator modifies the position of the camera 13 while making reference to the display 24 and thereafter checks the position of the camera 13. The operator repeats modification and checking of the position of the camera 13 until the position of the camera 13 is judged to be normal.

The presentation part such as the display 24 may also be attached to the top of the buffer cap 40. Also, the presentation part such as the calibration plate 35 with the calibration pattern 34 pre-applied on it may be attached to the top of the buffer cap 40. Also, an image of the calibration pattern 34 may be directly applied to the top of the buffer cap 40. That is, the buffer cap 40 itself may be made the presentation part indicating the calibration pattern 34 via an image pre-applied to its top.

As described above, in the adjustment assistance system 21 according to Embodiment 6, the portable terminal 22 with the presentation part such as the display 24 is positioned at the top of the buffer cap 40. The buffer cap 40 is a device to be placed on the first buffer 16 during adjustment work on the camera 13. The first buffer 16 is positioned below the car 9 at the lower end of the hoistway 2.

Such an arrangement shortens the distance from the surface of the display 24 and the like indicating the calibration pattern 34 at the top of the buffer cap 40 to the camera 13, so the calibration pattern 34 is easier to be detected. This allows calculation of the attitude of the camera 13 to be done more easily. Additionally, the position of the top of the buffer cap 40 is determined such as by the dimensions of the first buffer 16 and the buffer cap 40. This reduces variations among operators for the positional relationship between the surface of the display 24 and the like indicating the calibration pattern 34 and the camera 13. This facilitates work management of adjustment work on the camera 13.

The adjustment assistance system 21 also includes the position calculation part 39. The position calculation part 39 calculates the position of the camera 13 relative to the first buffer 16 based on the position, in an image captured by the camera 13, of the calibration pattern 34 detected from the image by the detection part 26 at the top of the buffer cap 40.

Such an arrangement makes the position of the camera 13 calculated with reference to the first buffer 16, which is fixed in position. This allows the operator to modify the position of the camera 13 more easily.

### INDUSTRIAL APPLICABILITY

The adjustment assistance systems according to the present disclosure can be applied to adjustment to the attitude of an elevator camera.

### REFERENCE SIGNS LIST

1 Elevator, 2 Hoistway, 3 Machine room, 4 Pit, 5 Hall, 6 Hatch door, 7 Traction machine, 8 Main rope, 9 Car, 10 Counterweight, 11 Control panel, 12 Car door, 13 Camera, 14 First guide rail, 15 Second guide rail, 16 First buffer, 17 Second buffer, 18 Remote monitoring apparatus, 19 Communication network, 20 Central control apparatus, 21 Adjustment assistance system, 22 Portable terminal, 23 Image acquisition part, 24 Display, 25 Display control part, 26 Detection part, 27 Measurement part, 28 Attitude calculation part, 29 Notification part, 30 Judgment part, 31 Adjustment value calculation part, 32 Scale, 33 Arrow, 34 Calibration pattern, 35 Calibration plate, 36 Holder, 37 Handle, 38 Stabilizer, 39 Position calculation part, 40 Buffer cap, 100a Processor, 100b Memory, 200 Dedicated hardware.

1. An elevator camera adjustment assistance system comprising:
a planar body that indicates on a surface thereof a calibration pattern to be captured by a camera provided on a car, which runs in a hoistway of an elevator, in the hoistway;
a sensor that is provided integrally with the planar body and measures an inclination of a normal line to the planar body with respect to a running direction of the car; and
processing circuitry;
to acquire an image captured by the camera;
to detect the calibration pattern in an acquired image; and
to calculate an attitude of the camera based on an inclination, with respect to an optical axis of the camera, of the normal line to the surface of the planar body indicating the detected calibration pattern.

2. (canceled)

3. The elevator camera adjustment assistance system according to claim 1, wherein the processing circuitry calculates an inclination of the camera with respect to the running direction of the car as the attitude of the camera, based on the image that was captured by the camera when the inclination measured by the sensor was an inclination within a calculation range, the calculation range being preset with respect to the running direction of the car.

4. The elevator camera adjustment assistance system according to claim 1, wherein the processing circuitry calculates an inclination of the camera with respect to the running direction of the car as the attitude of the camera, based on an inclination of the planar body that was measured by the sensor when the image in which the processing circuitry has detected the calibration pattern was captured by the camera.

5. The elevator camera adjustment assistance system according to claim 1, comprising:
a speaker that provides audio notification of information on whether or not the inclination measured by the sensor is an inclination within a notification range, the notification range being preset with respect to the running direction of the car.

6. The elevator camera adjustment assistance system according to claim 1, wherein
the processing circuitry outputs a signal for information representing the inclination measured by the sensor to a display that can be seen by an operator who performs adjustment work on the camera.

7. The elevator camera adjustment assistance system according to claim 1, wherein the planar body indicates the calibration pattern via an image pre-applied to the surface.

8. The elevator camera adjustment assistance system according to claim 7, comprising:
a display that shows an image based on an input signal,
wherein the processing circuitry outputs the signal representing an image to the display.

9. The elevator camera adjustment assistance system according to claim 8, wherein the display is positioned opposite the surface of the planar body.

10. The elevator camera adjustment assistance system according to claim 1, wherein
the processing circuitry outputs a signal representing the calibration pattern, and
the planar body is a display that indicates the calibration pattern on the surface in an indication based on the signal output by the processing circuitry.

11. The elevator camera adjustment assistance system according to claim 8, wherein the processing circuitry outputs to the display a signal representing whether detection of the calibration pattern by the processing circuitry was successful or not.

12. The elevator camera adjustment assistance system according to claim 8, wherein the processing circuitry outputs a past image that was captured by the camera when the attitude of the camera was a preset target attitude and a current image being captured by the camera such that the past image and the current image are superimposed on each other on the display.

13. The elevator camera adjustment assistance system according to claim 8, wherein the processing circuitry outputs a past image captured by the camera that was used in a most recent calculation of the attitude of the camera by the processing circuitry and a current image being captured by the camera such that the past image and the current image are superimposed on each other on the display.

14. The elevator camera adjustment assistance system according to claim 1, wherein
the processing circuitry judges an abnormality in the attitude of the camera based on a difference between the attitude the camera calculated by the processing circuitry and a preset target attitude.

15. The elevator camera adjustment assistance system according to claim 1, wherein
the processing circuitry calculates an adjustment value by which the attitude of the camera is adjusted to a preset target attitude based on the attitude of the camera calculated by the processing circuitry.

16. The elevator camera adjustment assistance system according to claim 1, comprising:
a handle to be held by an operator who performs adjustment work on the camera; and
a stabilizer that is attached to the handle and holds the planar body so as to maintain an inclination of the normal line to the planar body with respect to a running direction of the car.

17. The elevator camera adjustment assistance system according to claim 1, wherein the planar body is positioned at a top of a buffer cap, the buffer cap being placed on a buffer positioned below the car at a lower end of the hoistway during adjustment work on the camera.

18. (canceled)

19. The elevator camera adjustment assistance system according to claim 17, wherein
the processing circuitry calculates a position of the camera relative to the buffer based on a position, in an image captured by the camera, of the calibration pattern detected from the image by the processing circuitry at the top of the buffer cap.
